(19) United States
(12) Patent Application Publication
(10) Pub. No.: US 2011/0265593 A1
(43) Pub. Date: Nov. 3, 2011

(54) REDUCTION GEAR FOR WIND POWER GENERATION EQUIPMENT AND INSTALLATION METHOD THEREOF

(75) Inventors: Kiyoji MINEGISHI, Obu-shi (JP); Yuji YANO, Obu-shi (JP); You TSURUMI, Obu-shi (JP); Shun ABE, Obu-shi (JP)

(73) Assignee: SUMITOMO HEAVY INDUSTRIES, LTD., Tokyo (JP)

(21) Appl. No.: 13/096,038

(22) Filed: Apr. 28, 2011

(30) Foreign Application Priority Data
Apr. 30, 2010 (JP) 2010-105680

(51) Int. Cl. F16H 57/02; B23P 11/00

(52) U.S. Cl. 74/412 R; 29/893.1

(57) ABSTRACT

A reduction gear for wind power generation equipment includes a motor, an orthogonal cogwheel mechanism, a final-stage reduction mechanism, and an output pinion that are disposed on a power transmission path in this order; and a casing that accommodates the orthogonal cogwheel mechanism and the final-stage reduction mechanism and is capable of being separated into a high-speed casing body and a low-speed casing body between the orthogonal cogwheel mechanism and the final-stage reduction mechanism while confining a lubricant therein.

### BACKGROUND

1. Technical Field

The present invention relates to a reduction gear for wind power generation equipment and an installation method thereof.

The present application claims priority on Japanese Patent Application No. 2010-105680 filed on Apr. 30, 2010, the entire contents of which are incorporated herein by reference.

2. Description of the Related Art

A reduction gear used in wind power generation equipment is disclosed, for example, in the related art or the like. Reduction gears used in wind power generation equipment are classified into a yaw-driving reduction gear for rotating a nacelle (a power generation chamber), installed at the uppermost portion of a strut, in a horizontal plane, pitch-driving reduction gears for changing an angle of a wind turbine blade, or the like.

The nacelle of the wind power generation equipment is located at the uppermost portion of the strut, that is, at a position which is very high above the ground, and a space for disposing a control device or a reduction gear is narrow. For this reason, in the reduction gear relating to the related art, an “orthogonal cogwheel mechanism” is provided in a reduction gear so that the rotation of a motor is converted into a perpendicular direction and then output. The entire length of the reduction gear may be further shortened by setting the reduction gear to an orthogonal type.

### SUMMARY

According to an embodiment of the present invention, there is provided a reduction gear for wind power generation equipment, including a motor, an orthogonal cogwheel mechanism, a final-stage reduction mechanism, and an output pinion that are disposed on a power transmission path in this order, and a casing that accommodating the orthogonal cogwheel mechanism and the final-stage reduction mechanism and is capable of being separated into a high-speed casing body and a low-speed casing body between the orthogonal cogwheel mechanism and the final-stage reduction mechanism while confining a lubricant therein.

### BRIEF DESCRIPTION OF THE DRAWINGS

FIG. 1 is a sectional view showing an entire reduction gear for wind power generation equipment according to an embodiment of the invention.

FIG. 2 is a front view showing wind power generation equipment to which the reduction gear is applied.

FIG. 3 is a perspective view showing that the reduction gear for wind power generation equipment according to an embodiment of the invention is installed in a nacelle of the wind power generation equipment.

FIG. 4 is a sectional view showing a configuration of essential parts of a yaw driving device of the wind power generation equipment.

FIG. 5 is a plane view showing various installations of the reduction gear of FIG. 1.

FIG. 6 is an exploded sectional view showing a state where a backlash is checked while the reduction gear of FIG. 1 is separated.

FIG. 7 is a sectional view showing an entire reduction gear for wind power generation equipment according to another embodiment of the invention.

FIG. 8 is a sectional view showing an entire reduction gear for wind power generation equipment according to still another embodiment of the invention.

### DETAILED DESCRIPTION

However, if the reduction gear is an orthogonal type, there are problems in that not only is the reduction gear heavy but it also has inferior “weight balance” and is extremely difficult to handle. In other words, in a case where the reduction gear is fixed at a predetermined location in a nacelle, the reduction gear should be fixed in the narrow nacelle while taking a weight balance of the reduction gear and adjusting or checking a backlash by arranging the extending direction of a motor with the direction aligned within the space in the nacelle (a direction that does not interfere with the other mechanisms in the nacelle). For this reason, it is difficult to perform the above fixing work. It is desirable to provide a reduction gear of wind power generation equipment, which may be easily handled even in the narrow space within a nacelle.

In order to ensure a compact property of the entire reduction gear, in an embodiment of the invention, the orthogonal cogwheel reduction mechanism is inserted into the basic power transmission path. However, as described above, the orthogonal reduction gear has inferior weight balance and is not easily fixed while supporting the casing not to fall after rotating the entire casing. Also, in a case where it is intended to rotate the reduction gear due to any condition such as the adjustment of backlash, the motor and other instruments extending in the radial direction may interfere with the rotation.

In an embodiment of the invention, between the orthogonal cogwheel mechanism and the final-stage reduction mechanism, the casing may be separated into a high-speed casing body having the orthogonal cogwheel mechanism and a low-speed casing body having the final-stage reduction mechanism so that a lubricant is confined in each casing body.

In this way, for example, even when the reduction gear is put into the nacelle located at a high position in relation to the ground or the reduction gear is moved or installed in the nacelle, a worker may always handle about a half of the weight, thereby greatly improving the ease of handling. Also, since the installation can be made without a portion extending in a perpendicular direction, an installed article has superior weight balance, and it may be very easily handled during the installation (since the weight itself is reduced by a half).

In addition, since the low-speed casing body may be fixed to the nacelle while the motor and the high-speed casing body are not present, it is much easier to fix the low-speed casing body while checking or adjusting the backlash.

Further, since the high-speed casing body including the orthogonal cogwheel mechanism may be separated from the low-speed casing body so that the extension direction of the motor shaft may be changed without rotating the casing itself, it is possible to fix the low-speed casing body and then extend the motor in a direction not interfering with other instruments in the nacelle so that the high-speed casing body is easily connected to the low-speed casing body. For this reason, it is easy to change the extension direction of the motor shaft not only at the time of new installation, but also in accordance with future circumstances in the space of the nacelle.

According to an embodiment of the invention, as a reduction gear for wind power generation equipment, which should be installed in a nacelle having just a narrow space and provided at the high location in relation to the ground, it is possible to provide a reduction gear that may be very easily handled.

Hereinafter, a reduction gear for wind power generation equipment according to an embodiment of the invention will be described in detail.

First, the wind power generation equipment is described in general.

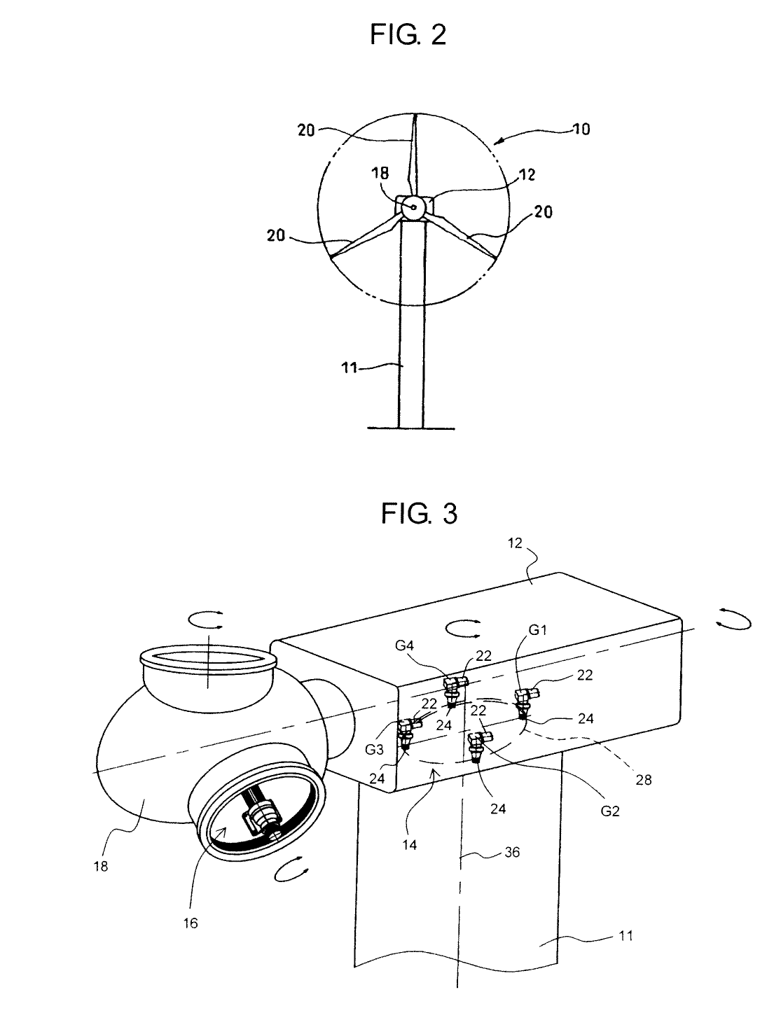

Referring to FIGS. 2 and 3, the wind power generation equipment 10 includes a nacelle (power generation chamber) 12 at an uppermost portion of a cylindrical strut 11. A yaw driving device 14 and a pitch driving device 16 are installed in the nacelle 12. The yaw driving device 14 is used for controlling a pivotal angle of the entire nacelle 12 with respect to the cylindrical strut 11, while the pitch driving device 16 is used for controlling a pitch angle of three wind turbine blades 20 mounted on a nose cone 18.

In this embodiment, since the invention is applied to the yaw driving device 14, the yaw driving device 14 is described here.

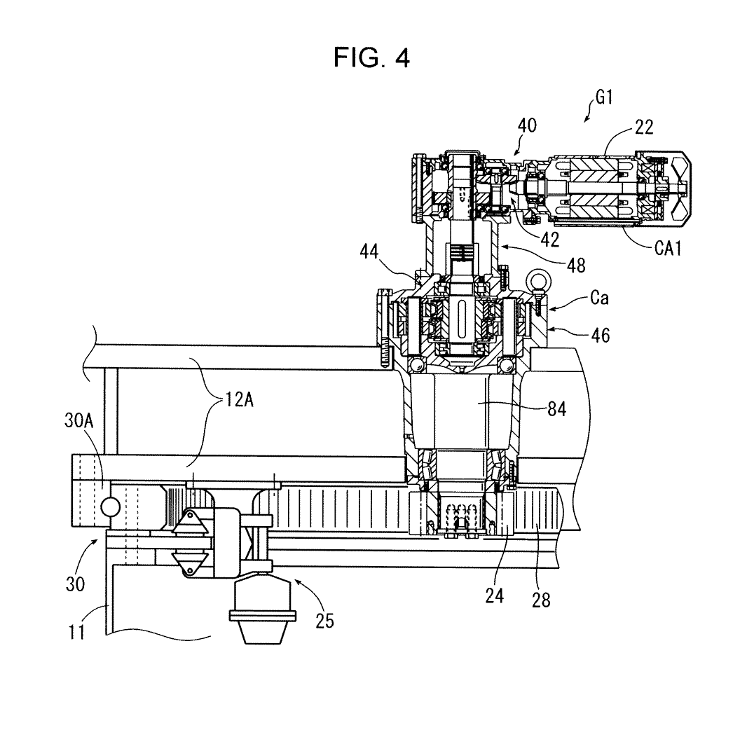

The yaw driving device 14 includes four reduction gears G1 to G4 respectively provided with a motor 22 and an output pinion 24, and one pivoting internal gear 28 engaged with each output pinion 24. Each of the reduction gears G1 to G4 is fixed to a predetermined location at a body side of each nacelle 12. Referring to FIG. 4, the pivoting internal gear 28 engaged with each output pinion 24 of each of the reduction gears G1 to G4 is fixed to the cylindrical strut 11 to configure an inner race of a yaw bearing 30. An outer race 30A of the yaw bearing 30 is fixed to a body 12A of the nacelle 12. Also, a reference numeral 25 of FIG. 4 represents a brake mechanism of the yaw driving device 14.

In this configuration, if the output pinions 24 are rotated at the same time by the motor 22 of the reduction gears G1 to G4, the output pinions 24 are engaged with the internal gear 28 to revolve around a center 36 (see FIG. 3) of the internal gear 28. As a result, the entire nacelle 12 may be pivoted around the center 36 of the internal gear 28 fixed to the cylindrical strut 11. In this way, the nose cone 18 may be directed toward a desired direction (for example, toward a wind) so that a wind pressure is efficiently received.

Since the reduction gears G1 to G4 have the same configuration, the reduction gear G1 is described here.

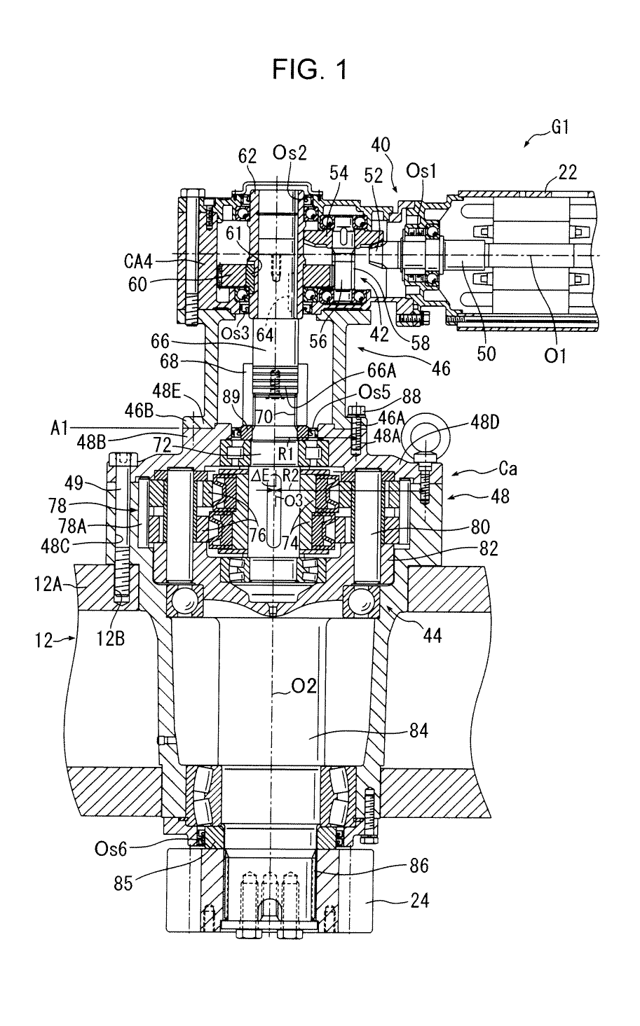

Referring to FIG. 1, the reduction gear G1 includes a motor 22, an orthogonal cogwheel mechanism 40, a parallel-shaft cogwheel mechanism 42, and a final-stage reduction mechanism 44, which are disposed in a casing Ca in this order on a power transmission path. Also, the casing Ca may be separated into a high-speed casing body 46 and a low-speed casing body 48. The configuration of the casing Ca will be described later in detail.

Hereinafter, the components are described in the order on the power transmission path. A motor shaft 50 of the motor 22 also serves as an input shaft of the orthogonal cogwheel mechanism 40. The orthogonal cogwheel mechanism 40 includes a hypoid pinion 52 vertically formed at the front end of the motor shaft 50, and a hypoid gear 54 engaged with the hypoid pinion 52 to change the rotation direction of the motor shaft 50 to a perpendicular direction. The hypoid gear 54 is fixed to an intermediate shaft 56. A spur-pinion 58 of the parallel-shaft cogwheel mechanism 42 is directly formed at the intermediate shaft 56.

The parallel-shaft cogwheel mechanism 42 has the spur-pinion 58 and a spur-gear 60 engaged with the spur-pinion 58. The spur-gear 60 is fixed to a hollow shaft 62 with a key 61 being interposed therebetween. The hollow shaft 62 is connected to a joint shaft 66 via the key 64.

A plurality of ring-shaped grooves 66A is formed at the front end portion of the joint shaft 66. An adhesive is filled in the grooves 66A. Also, a ring-shaped joint ring 68 is inserted while covering the grooves 66A filled with the adhesive. An input shaft 72 of the final-stage reduction mechanism 44 is fitted into a joint shaft opposite to the axial direction of the joint ring 68 with a spline 70 being interposed therebetween.

The final-stage reduction mechanism 44 includes the input shaft 72, two eccentric bodies 74 installed to the input shaft 72, two external gears 76 eccentrically shaking by means of the eccentric bodies 74, and an internal gear 78 inscribed to and engaged with the external gears 76. Two external gears 76 are shaken and rotated while keeping an eccentric state in opposite directions so that their eccentric phases are shifted as much as 180 degrees. The internal gear 78 is integrated with the low-speed casing body 48. The internal teeth of the internal gear 78 are respectively formed with cylindrical outer pins 78A. The number of the internal teeth of the internal gear 78 (the number of the outer pins 78A) is one more than the number of outer teeth of the external gear 76. An inner pin 80 is movably inserted into the external gear 76. The inner pin 80 is integrated with an output flange 82 so that the output flange 82 is integrated with an output shaft 84 of the reduction gear G1. In this embodiment, since the internal gear 78 is integrated with the low-speed casing body 48, if the input shaft 72 of the final-stage reduction mechanism 44 is rotated, the external gear 76 is shaken by means of the eccentric body 74, so that the relative rotation (the rotation on the axis thereof) of the external gear 76 with respect to the internal gear is drawn from the output shaft 86 by means of the inner pin 80 and the output flange 82. The aforementioned output pinion 24 is fixed and connected to the output shaft 84 via the spline 86 so that the pinion 24 is engaged with the already described pivoting internal gear 28 (FIGS. 3 and 4).

Here, the configuration of the casing Ca will be described in detail.

In this embodiment, the casing Ca of the reduction gear G1 may be separated into the high-speed casing body 46 and the low-speed casing body 48 at a portion of the line A1 by detaching a connection bolt 88. In this embodiment, the high-speed casing body 46 accommodates the orthogonal cogwheel mechanism 40 and also accommodates the parallel-shaft cogwheel mechanism 42. Meanwhile, the low-speed casing body 48 accommodates the final-stage reduction mechanism 44 of the reduction gear G1. When both casing bodies 46 and 48 are separated, the input shaft 72 (a power transmission shaft) of the low-speed casing body 48 protrudes over the cross-section 48E of the low-speed casing body 48, into a rotation-disabled state.

In this embodiment, there are provided 24 connection bolts 88 for connecting and aligning the low-speed casing body 48 to the high-speed casing body 46, so that corresponding connection bolt holes 46A and 48A are arranged at intervals of 15 degrees (360 degrees/24) on the circumference with a radius R1 of both flange portions 46B and 48B of the high-speed casing body 46 and the low-speed casing body 48. For this reason, the high-speed casing body 46 may be connected to the low-speed casing body 48 at an arbitrary angle (direction) with angular intervals of 15 degrees in the extension direction of the axial core O1 of the motor shaft 50.

Meanwhile, an installation hole 12B is formed at a predetermined location of the body 12A of the nacelle 12. An installation bolt hole 48C is formed at the low-speed casing body 48. The low-speed casing body 48 may be fixed to a predetermined location of the body 12A of the nacelle 12 by screwing an installation bolt 49 into the installation hole 12B of the nacelle 12 and the installation bolt hole 48C of the low-speed casing body 48. A plurality of installation holes 12B and installation bolt holes 48C are formed on the circumference of a radium R2 (24 holes in this embodiment) at regular intervals. Thus, the low-speed casing body 48 may be fixed to the body 12A of the nacelle 12 in a state of being rotated at an arbitrary angle at every 15 degrees (360 degrees/24).

The center of a circle (the center of the installation portion (the inside low portion) where the reduction gear G1 is mounted) O3 of a radius R2 where the installation bolt hole 48C is formed is intentionally shifted from the axial core (the axial core of the joint shaft 66, the input shaft 72, or the output pinion 24) O2 on the power transmission mechanism by ΔE. As a result, this configuration forms an “adjusting mechanism” which may adjust the axial core location with respect to the pivoting internal gear 28 of the output pinion 24. In this way, when the low-speed casing body 48 is fixed to the body 12A of the nacelle 12, the low-speed casing body 48 is fixed while adjusting the pitch circle of the engagement point between the output pinion 24 and the pivoting internal gear 28 engaged with the output pinion 24 (whenever the low-speed casing body 48 is rotated by 15 degrees), so that the backlash of the output pinion 24 and the pivoting internal gear 28 may be changed.

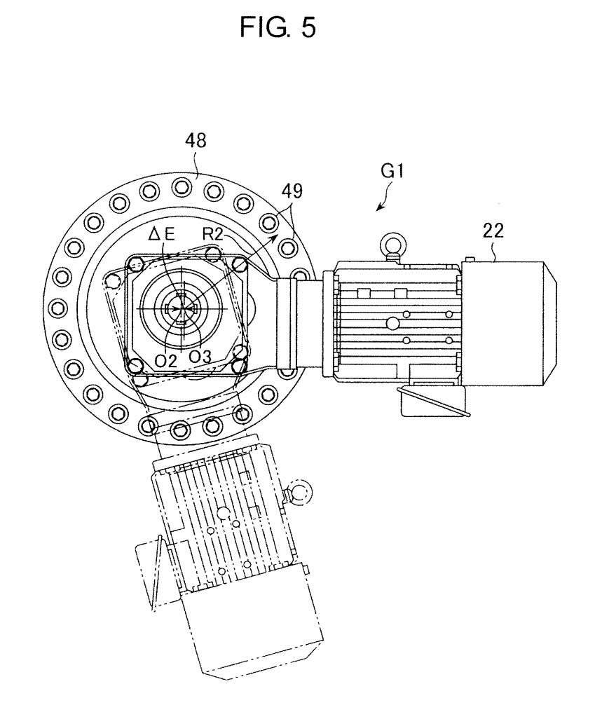

In addition, in this embodiment, for example, as shown in FIG. 5, the direction of the axial line O1 of the motor shaft 50 may also be changed by rotating the low-speed casing body 48 with respect to the body 12A of the nacelle 12 (see the imagined line). However, in this embodiment, since the rotation of the low-speed casing body 48 with respect to the nacelle 12 is performed mainly for the adjustment of backlash, the change of the extension direction of the axial core O1 of the motor shaft 50 is performed mainly by the rotation of the high-speed casing body 46 at the line A1 by means of the aforementioned connection bolt 88.

Meanwhile, on the high-speed casing body 46, an oil seal Os1 is disposed so that the oil seal Os1 prevents the lubricant of the orthogonal cogwheel mechanism 40 from leaking to the motor 22. Also, oil seals Os2 and Os3 are respectively disposed at both ends of the hollow shaft 62, so as to seal the space accommodating the orthogonal cogwheel mechanism 40 and the parallel-shaft cogwheel mechanism 42 together with the oil seal Os1. In this way, even if the high-speed casing body 46 is separated from the low-speed casing body 48, the lubricant is confined in the high-speed casing body 46 and does not leak out of the high-speed casing body 46.

Also for the low-speed casing body 48, a second joint ring 89 is disposed at the outer periphery of the input shaft 72 so that an oil seal Os5 is disposed between the second joint ring 89 and a cover body 48D of the low-speed casing body 48. In addition, at the front end portion of the output shaft 84, an oil seal Os6 is disposed between a ring member 85 inserted into the output shaft 84 and the low-speed casing body 48. Because of the oil seals Os5 and Os6, the lubricant is confined in the low-speed casing body 48 and does not leak out of the low-speed casing body 48.

Next, operations of the reduction gear G1 for the wind power generation equipment 10 according to this embodiment will be described.

The rotation of the motor shaft 50 of the motor 22 is primarily reduced due to the engagement between the hypoid pinion 52 and the hypoid gear 54 of the orthogonal cogwheel mechanism 40 while shifting the direction of the rotation shaft by as much as 90 degrees, and then is transferred to the intermediate shaft 56 of the parallel-shaft cogwheel mechanism 42. In addition, as the orthogonal reduction mechanism, an orthogonal cogwheel mechanism using a worm pinion and a worm gear is also known for example, in addition to the orthogonal cogwheel mechanism 40 having the hypoid pinion 52 and the hypoid gear 54. However, the orthogonal cogwheel mechanism using a worm pinion and a worm gear has a very low static efficiency, and thus a large motor is needed for operation. In addition, due to a high self-locking property (a property of not being operated by the force of a load), a great load at the output side is ensured until the reduction gear G1 itself breaks down. However, the orthogonal cogwheel mechanism 40 having the hypoid pinion 52 and the hypoid gear 54 (or, an orthogonal cogwheel mechanism having a bevel pinion and a bevel gear) does not endure a large load of an output side until the reduction gear G1 itself breaks down, but advantageously disperses the load to other reduction gears G2 to G4, due to a low self-locking property. In addition, when a load at the output pinion 24 is very great, in this embodiment, sliding occurs at the inserted connection portion of the joint ring 68 and the joint shaft 66 where the adhesive is used together as described later, which let the great load escape.

The rotation of the intermediate shaft 56 is reduced due to the engagement between the spur-pinion 58 and the spur-gear 60 and then transferred to the hollow shaft 62 by means of the key 61. The rotation of the hollow shaft 62 is transferred to the joint shaft 66 via the key 64. The rotation of the joint shaft 66 is transferred to the joint ring 68 due to the adhesive filled in the grooves 66A and the fitting caused by insertion, and is then transferred to the input shaft 72 of the final-stage reduction mechanism 44 connected to the inner periphery side of the joint ring 68 via the spline 70.

If the input shaft 72 of the final-stage reduction mechanism 44 is rotated, the external gear 76 is shaken and rotated (while being inscribed with the internal gear 78) by means of the eccentric body 74, so that the engagement location between the external gear 76 and the internal gear 78 is shifted in order. As a result, whenever the input shaft 72 of the final-stage reduction mechanism 44 makes one turn, the external gear makes one vibration (in a fixed state) so as to make a phase shift by one tooth with respect to the internal gear 78 (a rotation component is generated). This rotation component is taken out to the output shaft 84 by means of the inner pin 80 and the output flange 82, thereby realizing the reduction at the final-stage reduction mechanism 44. The rotation of the output shaft 84 is transferred to the output pinion 24 via the spline 86. Since the output pinion 24 is engaged with the pivoting internal gear 28 and also the internal gear 28 is fixed to the cylindrical strut 11, the nacelle 12 itself is resultantly rotated in a horizontal direction with respect to the cylindrical strut 11 due to the reaction.

Here, in this embodiment, the low-speed casing body 48 may be separated from the high-speed casing body 46 by detaching the connection bolt 88. Also, since the lubricant in each casing body 46 and 48 does not leak out of each casing body 46 and 48 due to the oil seals Os1 to Os3 or the oil seals Os5 and Os6, a worker who installs the reduction gear G1 may deal with (handle) the high-speed casing body 46 and the low-speed casing body 48 separately when putting the reduction gear G1 into the nacelle 12 or moving the reduction gear G1 in the nacelle 12. For this reason, for example, even one worker may handle the reduction gear G1 very easily.

The reduction gear G1 (to G4) is installed as follows. Also, when the reduction gears G1 to G4 are fixed to the nacelle 12, a brake mechanism 25 (FIG. 4) of the yaw driving device 14 is operated so that the nacelle 12 is fixed to the cylindrical strut 11. Also, in a case where the wind power generation equipment has no brake mechanism, the reduction gear is fixed by means of a vice or a vice-like fixing means.

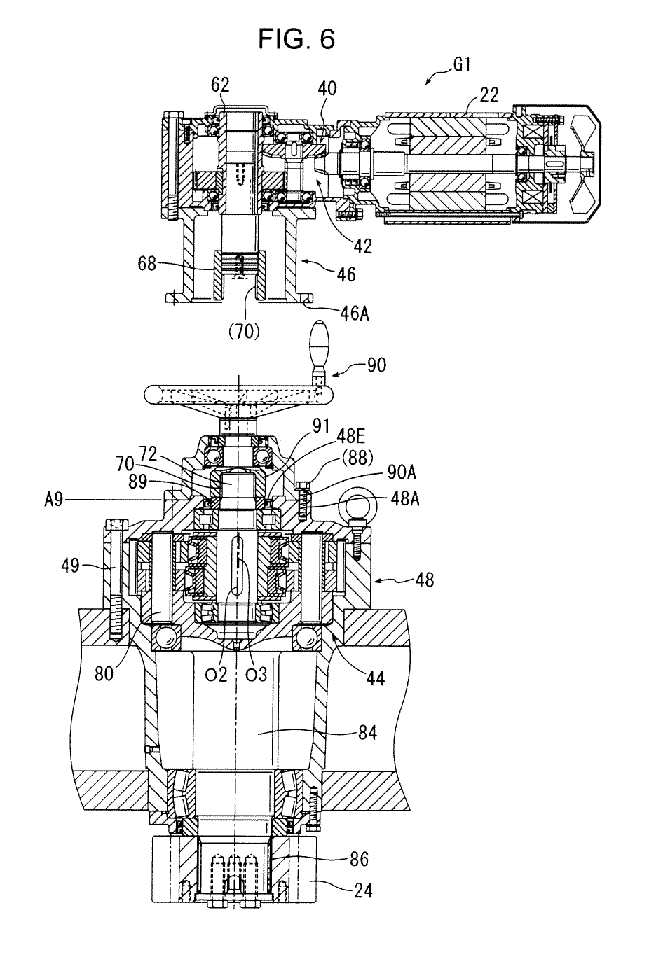

First, the low-speed casing body 48 of the reduction gear G1 is provisionally fixed to the installation hole 12B at a predetermined location in the nacelle 12 by means of, for example, about three installation bolts 49. As shown in FIG. 6, a handle jig 90 capable of rotating the input shaft 72 by the engagement with the input shaft 72 of the final-stage reduction mechanism 44 is mounted thereon to the low-speed casing body 48.

This handling jig 90 has a bolt hole 90A that is in agreement with the connection bolt hole 48A when the high-speed casing body 46 is mounted to the low-speed casing body 48, and a ring body 91 that may be engaged with the spline 70 of the input shaft 72 of the final-stage reduction mechanism 44. Thus, if the handle jig 90 is manually manipulated to rotate the input shaft 72 of the final-stage reduction mechanism 44 by means of the ring body 91, the output pinion 24 may be rotated within the range of backlash with the pivoting internal gear 28. For example, in a case where a reduction ratio of the final-stage reduction mechanism 44 is 1/30, a rotation angle that is 30 times greater than the backlash (a range allowing rotation) at the output pinion 24 may be checked.

Subsequently, as for the other three reduction gears S2 to S4, backlash is checked in entirely the same way. As a result of the checking, adjustment is made so that each backlash is within a predetermined range. This adjustment is performed by removing the provisionally fixed installation bolt 49 of a reduction gear Gng having an unsuitable backlash to rotate the reduction gear Gng in the unit of 15 degrees in any direction, and then provisionally fixing the installation bolt and checking the backlash again. Since the axial core O3 of a circle where the installation bolt 49 is disposed is eccentric from the axial core O2 of the output pinion 24 in the reduction gears G1 to G4 of this embodiment when the low-speed casing body 48 is fixed to the nacelle 12, a radial distance (pitch circle) of the output pinion 24 with respect to the pivoting internal gear 28 may be changed by means of the above adjustment, and resultantly the backlash of the reduction gear Gng may be changed. If required, the same adjustment is performed to two or three reduction gears. After the adjustment, the installation bolts 49 of all reduction gears G1 to G4 are fastened.

By fixing four reduction gears G1 to G4 while adjusting each corresponding backlash, all of the four reduction gears G1 to G4 may transmit power jointly.

Conventionally, such backlash is not accurately checked (detected), and the installation worker estimates the actual backlash between the output pinion 24 and the internal gear 28 from a subtle engagement between the tooth surfaces when the output pinion 24 is engaged with and fixed to the inner teeth of the pivoting internal gear 28. In other words, conventionally, if there is no great difference in backlash, it may be considered as “good”. Thus, in a case where the output pinion 24 is operated according to the rotation of the motor 22, the transferred torque is eventually no more than the torque generated by the motor 22, and thus there are sufficient margins in the strength of each member. Further, by controlling the current flowing in the motor 22 for example, it is possible to some degree to operate or control so that the reduction gears G1 to G4 could bear substantially equal loads.

However, things are different when a huge load of the wind turbine blade 20 is input from the output pinion 24. This huge “external load” is not able to be controlled in a way that the loads born by the reduction gears are equalized by controlling the current for example. In other words, the huge load tends to be focused more on a reduction gear physically having a small backlash. For this reason, eventually, it is considered that some reduction gears having a relatively smaller backlash receive greater loads in comparison to other reduction gears, which shortens their life spans. Once one reduction gear is broken, the load is focused on other reduction gears, and thus the reduction gears become broken one by one.

In this point, if backlashes of four reduction gears G1 to G4 are adjusted to be accurately within a predetermined range as in this embodiment, the four reduction gears G1 to G4 may always bear the huge load in a balanced way, and thus it is possible to prevent the huge load from being applied only to some reduction gears.

Further, in the reduction gears G1 to G4 of this embodiment, the casing Ca may be separated into the low-speed casing body 48 and the high-speed casing body 46 at the line A1. Also, the input shaft (power transmission shaft) 72 of the low-speed casing body 48 in a separated state protrudes over the cross section 48E of the low-speed casing body 48 in a rotatable state. For this reason, the backlash may be easily and accurately checked and adjusted without the high-speed casing body 46.

It is also necessary to adjust the backlash when the reduction gear is exchanged (due to the possibility of temporal change of the backlash itself), but even in this case, the reduction gear may be more easily exchanged since the backlash may be easily adjusted. In addition, in this embodiment, a plurality of installation bolt holes are provided concentrically, and the axial core of a circle where the plurality of installation bolt holes are arranged are eccentric from the axial core of the output pinion, which configures the “adjusting mechanism”, so that a pitch circle between the output pinion and a toothed wheel engaged with the output pinion may be changed to adjust the backlash between the toothed wheel and the output pinion as a result. However, the configuration for adjusting a backlash is not limited thereto. For example, bolt holes of any one side may have an elongated shape so that the fixed location of the entire low-speed casing body to the nacelle may be changed along the radial direction thereof for the axial core of the opposite toothed wheel (the pivoting internal gear 28 in the above embodiment), which allows the adjustment of backlash.

After the low-speed casing body 48 is completely installed to the nacelle 12, the high-speed casing body 46 is fixed to the low-speed casing body 48 (including the motor 22 and the orthogonal cogwheel mechanism 40) while arbitrarily setting the axial direction O1 of the motor 22. In this embodiment, 24 connection bolt holes 46A and 48A for connecting the low-speed casing body 48 to the high-speed casing body 46 are formed and arranged at regular intervals at every 15 degrees in the circumferential direction. For this reason, the high-speed casing body 46 may be connected to the low-speed casing body 48 so that the extension direction of the axial core O1 of the motor 22 is at any angle at every 15 degrees. For this reason, the mounting work may be performed after the axial core O1 of the motor 22 is moved to a direction allowing easier mounting work in the narrow space of the nacelle 12.

In addition, in this embodiment, since the connection structure using the insertion and the adhesive filled in the grooves 66A together is adopted as a structure of transmitting power to the input shaft 72 of the final-stage reduction mechanism 44, for example, in a case where the final-stage reduction mechanism 44 is forcibly rotated from the output pinion 24 due to an excessive load from the wind turbine blade 20, the excessive load may be favorably allowed to escape since slipping occurs at the portion. In addition, the experiments of the inventor confirmed that the connection structure in which the adhesive and the insertion are combined may be restored to a connection state allowing the transmission of torque before the slipping, if the huge load disappears (since the wind stops).

Due to this synergetic effect, in this embodiment, a plurality of reduction gears G1 to G4 may be easily handled and easily installed to be able to bear a load substantially equally, and as a result the life spans of all the reduction gears G1 to G4 may be improved.

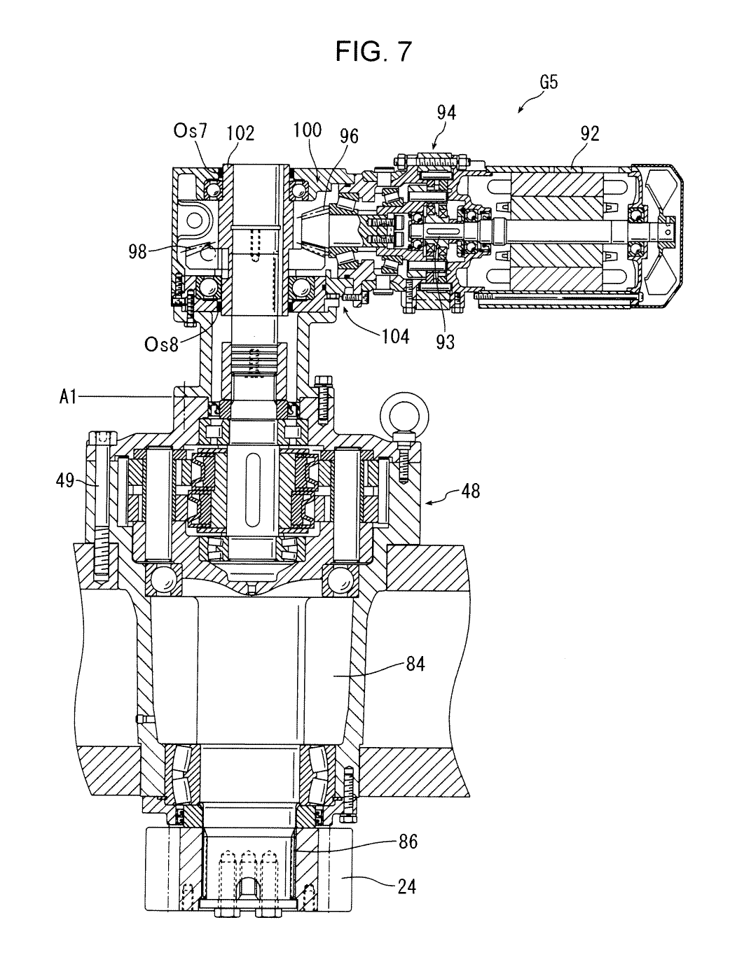

In addition, in the reduction gear according to an embodiment of the invention, the detailed structure of the reduction mechanism is not limited to the above reduction mechanism. For example, in the reduction gear G5 shown in FIG. 7, an oscillation inscribed engaging planetary cogwheel mechanism 94 that receives the rotation of the motor 92 is installed as a first-stage reduction mechanism. The oscillation inscribed mesh planetary cogwheel mechanism 94 basically has substantially the same structure as the final-stage reduction gear 44 of the above embodiment (though there are some differences, for example the overall size thereof is different due to the torque handled, and the inner pin 93 does not have dual support). In the embodiment shown in FIG. 7, the output of the first-stage oscillation inscribed mesh planetary cogwheel mechanism 94 is transferred to an orthogonal cogwheel mechanism 100 from the bevel gear 98 and the bevel pinion 96 and reduced here, and also the rotation direction thereof is shifted perpendicularly. Though the parallel-shaft cogwheel mechanism used in the former embodiment is not installed to the rear end of the orthogonal cogwheel mechanism 100, since the first-stage oscillation inscribed mesh planetary cogwheel mechanism 94 has a great reduction ratio, a greater reduction ratio may be obtained in total in comparison to the former embodiment. Oil seals Os7 and Os8 are disposed at both ends of the hollow shaft 102 of the orthogonal cogwheel mechanism 100, so that the lubricant in the high-speed casing body 104 does not leak out even when the low-speed casing body 48 is separated. The separating structure of the high-speed casing body 104 and the low-speed casing body 48 at the line A1 is identical to that of the former embodiment, and the structure of the low-speed casing body 48 is identical to that of the former embodiment, including the adopted structure of the final-stage reduction mechanism 44 and the seal structure of the lubricant. For this reason, the same reference numerals indicating the same components are not used in the figure, and the same components are not described again. Even in this embodiment, the same operational effects as in the former embodiment may be obtained.

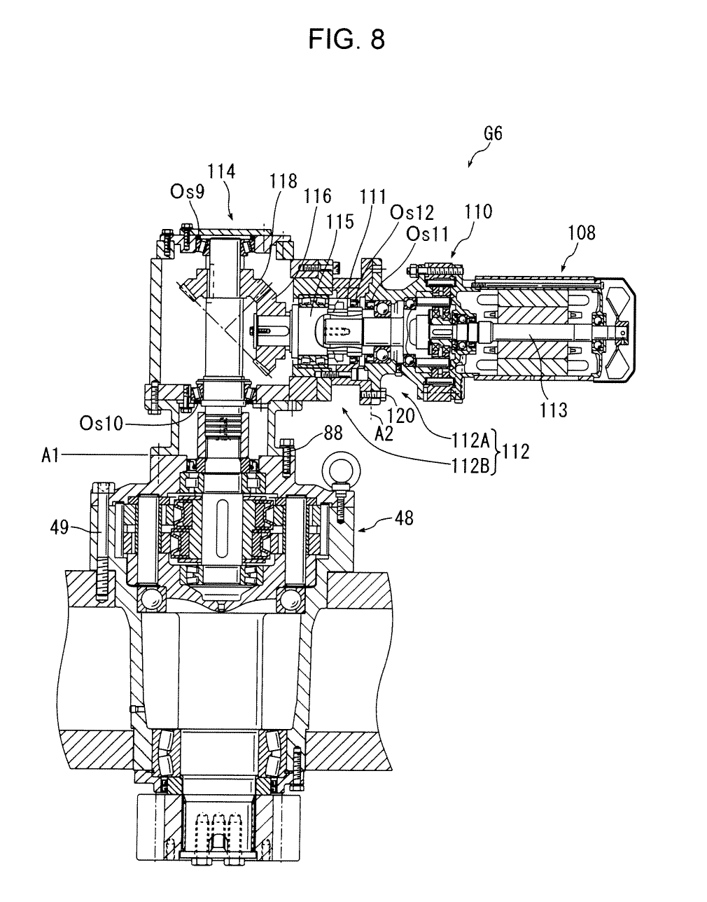

FIG. 8 shows a further embodiment of the reduction gear for the wind power generation equipment 10 according to the invention.

The reduction gear G6 of this embodiment also has an inscribed mesh planetary cogwheel reduction mechanism 110 that receives the rotation of a motor 108 at a first stage, so that the low-speed casing body 48 having the same structure as in the former embodiment may be connected to and separated from the high-speed casing body 112 at the line A1 by means of the connection bolt 88. The output of the inscribed mesh planetary cogwheel reduction mechanism 110 is transmitted to a joint shaft 115 via a spline 111 and then reaches a constant-speed orthogonal cogwheel mechanism 114. The constant-speed orthogonal cogwheel mechanism 114 shifts only the direction of the rotary shaft to a perpendicular direction (without any reduction), and here the constant-speed cogwheel mechanism 114 includes a pair of bevel gears 116 and 118.

Also, since the lubricant of the high-speed casing body 112 is confined in the high-speed casing body 112 by means of oil seals Os9 and Os10, the lubricant does not leak out even when the low-speed casing body 48 is separated from the high-speed casing body 112 and the extension direction of the motor shaft 113 of the high-speed casing body 112 may be freely changed in units of 15 degrees by means of the connection at the connection bolt 88. The structure of the low-speed casing body 48 is identical to that in the former embodiment, and the backlash may be adjusted in entirely the same way as in the former embodiment.

In addition, in this embodiment, due to the presence of oil seals Os11 and Os12, it is possible to carry out separation into a first high-speed casing body 112A and a second high-speed casing body 112B by means of a connection bolt 120, in the region of the line A2 at the rear end of the first-stage inscribed mesh planetary cogwheel reduction mechanism 110. Thus, for example, in consideration of the adjustment of backlash, the backlash may also be checked by separating the first high-speed casing body 112A and the second high-speed casing body 112B and then mounting a handle jig (not shown) fitted to the spline 111 of the joint shaft 115. In other words, it is not always necessary to check the backlash between the orthogonal cogwheel mechanism and the final-stage reduction mechanism.

In an embodiment of the invention, it is not particularly limited how the orthogonal cogwheel mechanism and other reduction mechanism other than the final-stage reduction mechanism are assembled. The portion where the casing is separated into a high-speed casing body and a low-speed casing body is not particularly limited, and the degree of freedom in setting a direction may be obtained at the rear end of the orthogonal cogwheel mechanism or at a further front end in relation to the final-stage reduction mechanism. Thus, it is possible to suitably carry out design in consideration of structure, shape, or size of each reduction mechanism of the reduction gear. The place where separation is made need not be one place, but the casing may be separated at two or more portions into three or more casing bodies.

The orthogonal cogwheel mechanism is not limited to a reduction mechanism using a hypoid gear or a reduction mechanism using a bevel gear, but may adopt a reduction mechanism using a worm, for example. As in the embodiment of FIG. 8, the orthogonal cogwheel mechanism may not be a reduction mechanism, but may be a constant-speed mechanism or a speed-increasing mechanism for the adjustment of an overall reduction ratio.

Configurations of cogwheel mechanisms other than the orthogonal cogwheel mechanism are also not particularly limited. For example a simple planetary cogwheel mechanism may also be used in addition to the parallel-shaft cogwheel mechanism and the oscillation inscribed mesh planetary cogwheel mechanism, described above. Also, for example, it is also possible that two-stage oscillation inscribed mesh planetary cogwheel mechanism is provided at the rear end of the orthogonal cogwheel mechanism.

In addition, though 24 connection bolt holes for connecting the high-speed casing body to the low-speed casing body are formed so that the high-speed casing body may be rotated at intervals of 15 degrees with respect to the low-speed casing body (the extension direction of the motor shaft may be selected), the number of connection bolt holes is not limited to 24. In addition, (though the number of directions that can be selected is decreased), the connection bolt holes may not be formed in a concentric field. For example, it is also possible that, though 24 strengthening bolts are prepared, the locations of connection bolt holes may be associated with each other and arranged in a rectangular condition, so that the extension direction of the motor shaft is capable of being changed only in four directions as a result. In this case, the degree of freedom in relation to the formation locations of the connection bolt holes of each casing may be further enhanced. Further, though the connections between casings or between a casing and the nacelle are made by bolt connection bodies in this embodiment, the invention is not limited thereto, but a connection mechanism using a wedged mechanism and a locking mechanism in combination may also be used. Also, this configuration may also be applied to the installation bolt holes.

In addition, though the invention further has a configuration for allowing easier adjustment of backlash by using the fact that the casing is separated into the high-speed casing body and the low-speed casing body (for example, the axial core of a circle where the plurality of installation bolts is arranged is eccentric from the axial core of the output pinion, the power transmission shaft of the low-speed casing body may be manipulated to rotate while the casing is in a separated state, or the power transmission shaft of the low-speed casing body protrudes over the cross-section of the low-speed casing body), such a configuration for the adjustment of backlash is not essential to the invention.

Also, though an example in which the invention is applied to the yaw driving device is included in this embodiment, for example, the invention may obtain the same operation effect by applying the invention to a reduction gear of a pitch driving device.

It should be understood that the invention is not limited to the above-described embodiment, but may be modified into various forms on the basis of the spirit of the invention. Additionally, the modifications are included in the scope of the invention.

We claim:

1. A reduction gear for wind power generation equipment, comprising:
a motor, an orthogonal cogwheel mechanism, a final-stage reduction mechanism, and an output pinion that are disposed on a power transmission path in this order; and
a casing that accommodates the orthogonal cogwheel mechanism and the final-stage reduction mechanism and is capable of being separated into a high-speed casing body and a low-speed casing body between the orthogonal cogwheel mechanism and the final-stage reduction mechanism while confining a lubricant therein.

2. The reduction gear for wind power generation equipment according to claim 1, further comprising a connection unit that connects the high-speed casing body and the low-speed casing body,
wherein the connection unit is capable of adjusting relative locations of the high-speed casing body and the low-speed casing body in a circumferential direction so that an extension direction of the motor is changeable.

3. The reduction gear for wind power generation equipment according to claim 2,
wherein the connection unit includes a plurality of connection bolt holes and bolts formed at the high-speed casing body and the low-speed casing body in the circumferential direction.

4. The reduction gear for wind power generation equipment according to any one of claim 1, further comprising an adjusting mechanism capable of adjusting an axial core location of the output pinion when the low-speed casing body is fixed to a predetermined location of the wind power generation equipment,
wherein a backlash of the output pinion and a toothed wheel is changeable by changing a pitch circle of an engagement point between the output pinion and the toothed wheel engaged with the output pinion.

5. The reduction gear for wind power generation equipment according to claim 4,
wherein the adjusting mechanism has a plurality of installation bolt holes for fixing the low-speed casing body to a predetermined location of the wind power generation equipment so that an axial core of a circle where the plurality of installation bolt holes is disposed is eccentric from an axial core of the output pinion, and thus the adjusting mechanism changes a backlash of the output pinion and the toothed wheel by changing the pitch circle of the engagement point between the output pinion and the toothed wheel engaged with the output pinion.

6. The reduction gear for wind power generation equipment according to claim 4,
wherein a power transmission shaft of the low-speed casing body is capable of being manipulated to rotate while the casing is in a separated state.

7. The reduction gear for wind power generation equipment according to claim 6,
wherein the power transmission shaft of the low-speed casing body protrudes over a cross section of the low-speed casing body while the casing is in a separated state.

8. The reduction gear for wind power generation equipment according to claim 1,
wherein the orthogonal cogwheel mechanism is a hypoid reduction mechanism.

9. A method for installing a reduction gear for wind power generation equipment, in which the reduction gear for wind power generation equipment including a motor, an orthogonal cogwheel mechanism, a final-stage reduction mechanism, and an output pinion is fixed to a predetermined location of the wind power generation equipment, the method comprising:
preparing a casing that accommodates the orthogonal cogwheel mechanism and the final-stage reduction mechanism so that the casing includes a high-speed casing body including the orthogonal cogwheel mechanism and a low-speed casing body including the final-stage reduction mechanism in a separated state;
temporarily fixing the low-speed casing body to a predetermined installation location of the wind power generation equipment that includes a center deviated from an axial core of the output pinion;
checking a backlash of the output pinion with respect to a toothed wheel of the wind power generation equipment by rotating an input shaft of the reduction mechanism accommodated in the low-speed casing body; and
fixing the low-speed casing body again by rotating the low-speed casing body in a circumferential direction in response to the backlash checking result.
